(19) United States
(12) Patent Application Publication
(10) Pub. No.: US 2011/0265001 A1
(43) Pub. Date: Oct. 27, 2011

(54) Cameraless A/V documenting of user interactions with MFP device user interface

(76) Inventors: Roniie Neil Patton, Lake Oswego, OR (US); Neil Joseph Runde, Brush Prairie, WA (US)

(21) Appl. No.: 12/799,284

(22) Filed: Apr. 21, 2010

(51) Int. Cl. G06F 3/01; G06F 3/041; H04N 5/93

(52) U.S. Cl. 715/702; 715/704; 345/173; 386/E05.003

(57) ABSTRACT

Methods and systems for cameraless audiovisual (A/V) documenting of user interactions with a multifunction peripheral (MFP) device user interface. User interactions are documented in an A/V file that is essentially a motion picture recorded without a camera, and that captures digital image edits or selections made on the user interface by a walk-up user along with the user's audio narration. The A/V file can be advantageously used, by way of example, as a dynamic presentation, or in MFP device training, diagnostics or support provisioning.

### BACKGROUND OF THE INVENTION

The present invention relates to advanced imaging device functionality and, more particularly, cameraless methods and systems for documenting user interactions with a multifunction peripheral (MFP) device user interface.

Imaging devices, such as MFP devices, support a broad array of imaging tasks, such as copying, faxing and printing. MFP devices typically provide a user interface (e.g. front panel) on which selections can be made by a walk-up user to manage imaging tasks. However, these MFP devices are not known to have native functionality to document selections made by a walk-up user in an audiovisual (A/V) sequence, which could greatly facilitate MFP training, diagnostics and support provisioning.

In addition to imaging tasks, some MFP devices support advanced functionality, such as digital image editing. For example, some MFP devices provide a user interface having a touch screen video display on which a static digital image (e.g. document, photograph, etc.) can be displayed and edited by a walk-up user through direct touches on the static image to generate a modified static image. However, these MFP devices are not known to have native functionality to document edits to the static image by the walk-up user in a A/V sequence, which could allow the walk-up user to convert the static image into a dynamic presentation from the imaging node front panel (i.e. without having to return to his or her personal computer).

Documenting user interactions with an MFP user interface in an A/V sequence can be achieved by focusing a video camera on the user interface of the MFP device and recording the edits or selections made by a walk-up user along with his or her audio narration. However, this is cumbersome, as it require holding, focusing and operating the camera as well as ensuring that the camera's field of view is not obstructed during the shoot. Moreover, if the A/V sequence recorded by the camera is intended for playback on devices on a computer network, offloading the A/V sequence from the camera to the network and converting the A/V sequence into a file format suitable for playback is required.

### SUMMARY OF THE INVENTION

The present invention provides methods and systems for cameraless A/V documenting of user interactions with an MFP device user interface. User interactions are documented in an A/V file that is essentially a motion picture recorded without a camera, and that captures digital image edits or selections made on the user interface by a walk-up user along with the user's audio narration. The A/V file can be advantageously used, by way of example, as a dynamic presentation, or in MFP device training, diagnostics or support provisioning.

In one aspect of the invention, therefore, an MFP device comprises a user interface having a touch screen video display and a microphone, a network interface, and a processor communicatively coupled with the user interface and the network interface, wherein under control of the processor the MFP device generates an A/V file containing a video sequence capturing one or more edits made in a cameraless recording session to a digital image rendered on the touch screen video display and an audio sequence capturing one or more sounds detected by the microphone, and transmits the A/V file to a network destination via the network interface.

In some embodiments, the video sequence is created from a series of recorded bitmap images of the digital image capturing a present state of the digital image.

In some embodiments, the edits are made through touches on the digital image.

In some embodiments, the touches are hand touches.

In some embodiments, the touches are stylus touches.

In some embodiments, the recording session is started and ended through touches on the user interface.

In some embodiments, the recording session is paused and resumed through touches on the user interface.

In some embodiments, a file format for the A/V file is selected through a touch on the user interface.

In some embodiments, the destination is selected through a touch on the user interface.

In some embodiments, the sounds are detected in the cameraless recording session.

In some embodiments, the sounds are detected in a second cameraless recording session in which the video sequence is played-back on the user interface.

In another aspect of the invention, an MFP device comprises a user interface having a microphone, and a processor communicatively coupled with the user interface, wherein under control of the processor the MFP device generates an A/V file containing a video sequence capturing one or more state changes to the user interface in a cameraless recording session and an audio sequence capturing one or more sounds detected by the microphone, and transmits the A/V file to a destination.

In some embodiments, the video sequence is created from a series of recorded bitmap images of the user interface capturing a present state of the user interface.

In some embodiments, the state changes include state changes made through touches on the user interface.

In some embodiments, the state changes include state changes made through touches on touch panel video display buttons and hard keys.

In some embodiments, the recording session is started and ended through touches on the user interface.

In some embodiments, a file format and the destination for the A/V file are selected through touches on the user interface.

In some embodiments, the sounds are detected in the cameraless recording session.

In some embodiments, the sounds are detected in a second cameraless recording session in which the video sequence is played-back on the user interface.

In some embodiments, the destination is on the MFP device.

In some embodiments, the destination is a destination device that is communicatively coupled with the MFP device over a communication network.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the invention is operative in some embodiments.

FIG. 2 shows an MFP device in some embodiments of the invention.

FIG. 3 shows a user interface of an MFP device displaying a home page in some embodiments of the invention.

FIG. 4 shows a user interface of an MFP device displaying an editable digital image in some embodiments of the invention.

FIG. 5 shows a user interface of an MFP device displaying an edited digital image in some embodiments of the invention.

FIG. 6 shows a bitmap image capturing edits made to a digital image in some embodiments of the invention.

FIG. 7 shows a cameraless method for documenting in an A/V sequence digital image edits made on a user interface of an MFP device in some embodiments of the invention.

FIG. 8 shows a user interface of an MFP device displaying a home page in some embodiments of the invention.

FIG. 9 shows a bitmap image capturing a state change to the user interface in some embodiments of the invention.

FIG. 10 shows a cameraless method for documenting in an A/V sequence state changes to a user interface of an MFP device in some embodiments of the invention.

### DETAILED DESCRIPTION OF A PREFERRED EMBODIMENT

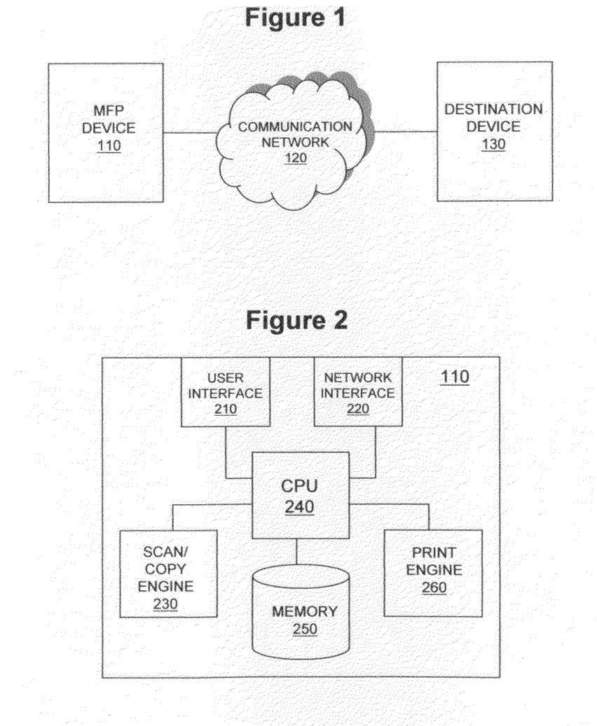

FIG. 1 shows a communication system in which the invention is operative in some embodiments. The system includes an MFP device 110 and a destination device 130 communicatively coupled via a communication network 120. In operation, MFP device 110 transmits to destination device 130 an A/V file that contains a video sequence and audio sequence. The video sequence captures digital image edits or user interface state changes (e.g. user interface selections) occurring during a cameraless recording session conducted on a user interface of MFP device 110. The audio sequence captures sounds detected during the cameraless recording session, or during a follow-up audio-only recording session. Destination device 130 may be a storage device or a playback device, such as a personal computer. Where destination device 130 is a storage device, device 130 stores the A/V file for subsequent accessing by playback devices. Where destination device 130 is a playback device, device 130 plays the A/V file on a user interface of destination device 130.

Communication network 120 is a data communication network that communicatively couples MFP device 110 and destination device 130. Communication network 120 may include one or more wired or wireless local area network (LAN), wide area network (WAN), World Interoperability for Microwave Access (WiMAX), cellular network, ad-hoc and/or other network nodes to facilitate communicative coupling. Alternatively, MFP device 110 and destination device 130 may be communicatively coupled over a direct wired or wireless link, such as a Universal Serial Bus (USB), Institute of Electrical and Electronics Engineers (IEEE) 1394 (Firewire), IEEE 802.3 (Ethernet), IEEE 802.11 (WiFi), Bluetooth or Infrared Data Association (IrDa) connection.

Turning to FIG. 2, MFP device 110 is shown in more detail in some embodiments of the invention. MFP device 110 supports multiple imaging services, such as copying, faxing and printing, and related services such as filing, format conversion and scanning. MFP device 110 has a user interface 210 for receiving inputs from walk-up users. MFP device 110 has a wired and/or wireless network interface 220, such as a USB, Firewire, Ethernet, WiFi, Bluetooth or IrDa interface, that communicatively couples MFP device 110 to communication network 120 and, in some embodiments, to peripheral devices (e.g. USB thumb drive, external hard drive, etc.). Network interface 220 may have multiple ports, and those multiple ports may support the same or different data communication protocols.

MFP device 110 receives via user interface 210 and/or network interface 220 imaging jobs, such as copy jobs, fax jobs, filing jobs, format conversion jobs, print jobs and scan jobs, and processes those imaging jobs. Imaging jobs address content (e.g. documents, photographs, etc.) and may be accompanied by a digital image of the content, a reference to a location of a digital image of the content or a hard copy of the content to be digitally imaged. Imaging jobs may also be accompanied by job settings.

Internal to MFP device 110, user interface 210, network interface 220, a scan/copy engine 230, a memory 250 and a print engine 260 are communicatively coupled with a processor (CPU) 240.

Scan/copy engine 230 includes scanner/copier logic, such as one or more integrated circuits (ICs), and a mechanical section for performing scanning and copying functions. Scan/copy engine 230 may, for example, have a line image sensor mounted on a movable carriage for optically scanning under the control of a scanner IC a digital image placed on exposure glass of MFP device 110.

Memory 250 has a storage element for persistently storing digital images, a storage element for persistently storing A/V files generated under control of processor 240 and a storage element for temporarily storing bitmap images and audio data for subsequent compilation into A/V files. Each A/V file includes a video sequence and an audio sequence. Each video sequence captures digital image edits or user interface state changes (e.g. user interface selections) occurring during a cameraless recording session conducted on user interface 210. Each audio sequence captures sounds detected on user interface 210 during the cameraless recording session, or during a follow-up audio-only recording session. In other embodiments, storage facilities for storing digital images, A/V files and/or bitmap images and audio data may reside outside of MFP device 110.

Print engine 260 includes printer logic, such as one or more printer ICs, and a mechanical section, such as a color ink jet head mounted on a movable carriage or a toner powder fusing system, for outputting digital images in hard copy format under control of the one or more printer ICs.

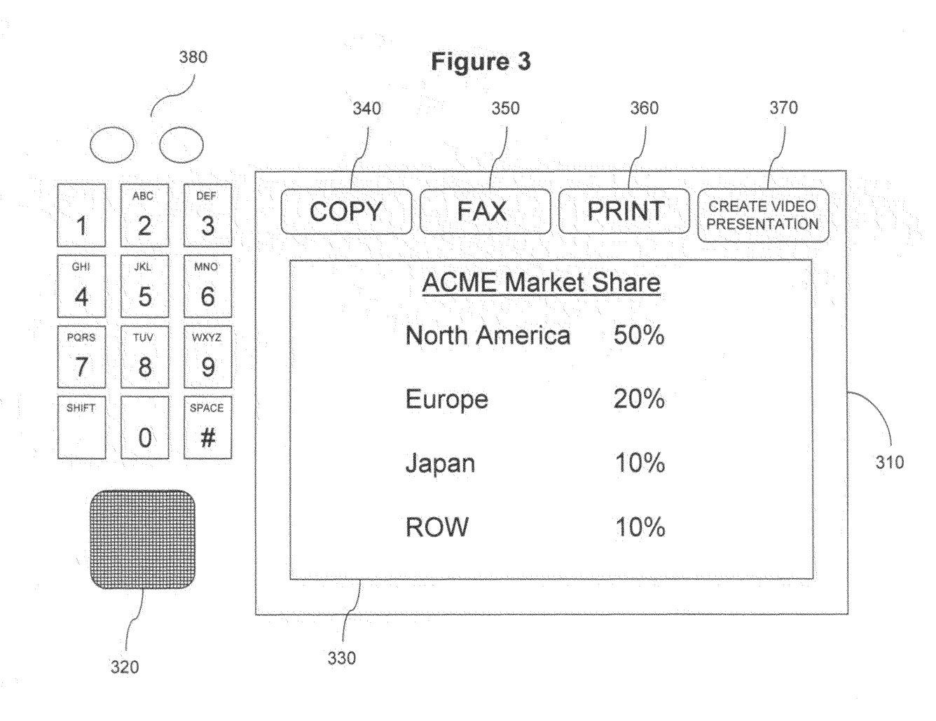

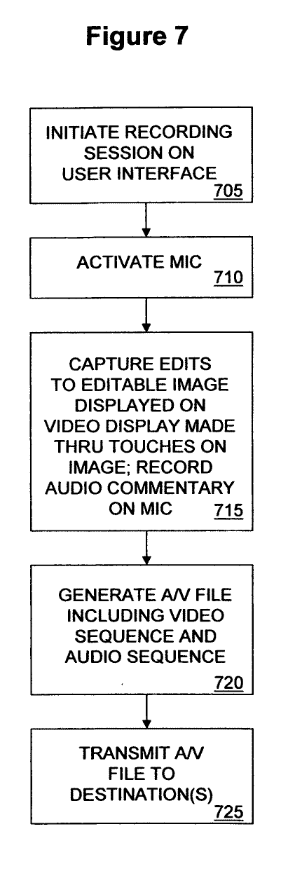

FIG. 7 shows a cameraless method for documenting in an A/V sequence digital image edits made on user interface 210 in some embodiments of the invention. This method will be described in conjunction with FIGS. 3-6.

At the outset, a walk-up user approaches MFP device 110 and indicates an intent to create an A/V presentation. Turning to FIG. 3, when the walk-up user arrives at MFP device 110, user interface 210 displays a home page on a touch screen video display 310. User interface 210 also includes a microphone 320 and hard keys 380. The home page displays action buttons including a COPY button 340, a FAX button 350, a PRINT button 360 and a CREATE VIDEO PRESENTATION button 370. The home page also displays a current digital image 330. Current digital image 330 is shown as a digital document, but may be another type of digital image such as a digital photograph. The current digital image may be, for example, a digital document (e.g. presentation slide, memorandum, etc.) or a digital photograph created by scanning a hard copy placed on exposure glass of scan/copy engine 230, received via network interface 220 as part of a copy job, fax job, filing job, format conversion job or print job, or retrieved from memory 250. The walk-up user indicates an intent to create an NV presentation by depressing CREATE VIDEO PRESENTATION button 370 by hand or using a stylus, for example.

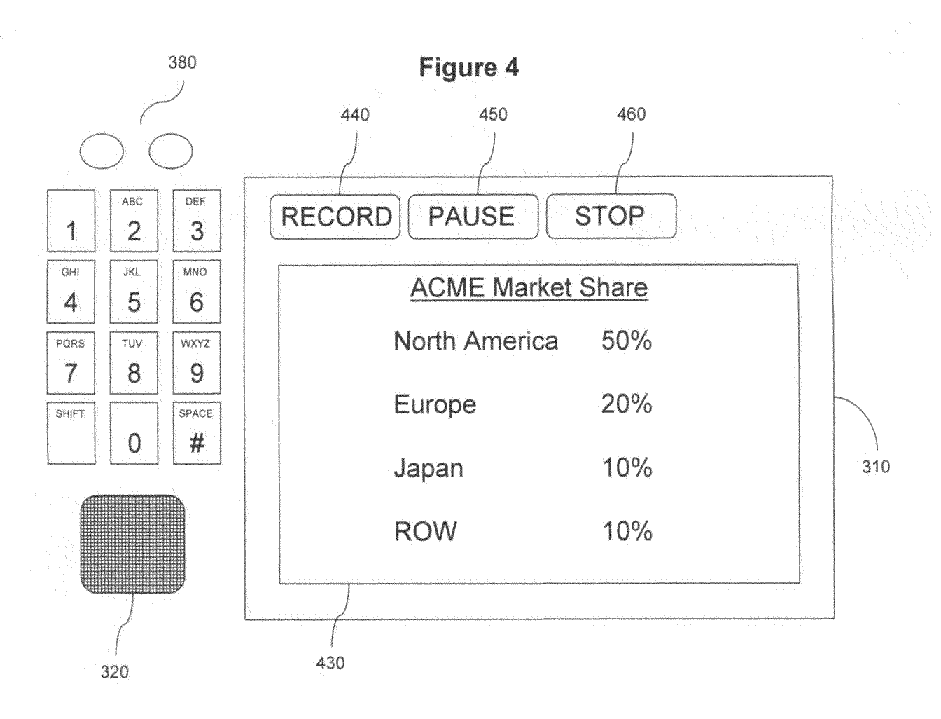

Next the walk-up user initiates a recording session on user interface 210 (705). Turning to FIG. 4, in response to depression by the walk-up user of the CREATE VIDEO PRESENTATION button 370, a recording session page is displayed on touch screen video display 310. The recording session page displays action buttons including a RECORD button 440, a PAUSE button 450 and a STOP button 460. The recording session page also displays an editable version of the current digital image 430. The walk-up user initiates the recording session by depressing RECORD button 440.

Next, in response to initiation of the recording session, MFP device 110 under control of processor 240 activates microphone 320 (710).

Next, MFP device 110 under control of processor 240 captures edits to editable image 430 made by the walk-up user and related audio commentary spoken into microphone 320 by the walk-up user (715). Edits to editable image 430 are made by hand or stylus touches directly on editable image 430 and are immediately reflected on editable image 430. The edits are captured in a series of time-stamped bitmap images each reflecting the present state of editable image 430, which is evolving. The bitmap images and accompanying audio data capturing sounds detected by microphone 320 are stored in memory 250. The walk-up user may temporarily suspend the recording session by depressing PAUSE button 450, and may resume the recording session by depressing RECORD button 440. Moreover, the walk-up user may terminate the recording session by depressing STOP button 460, at which point the user is queried as to how he or she wishes to dispose of the recorded video and audio sequences.

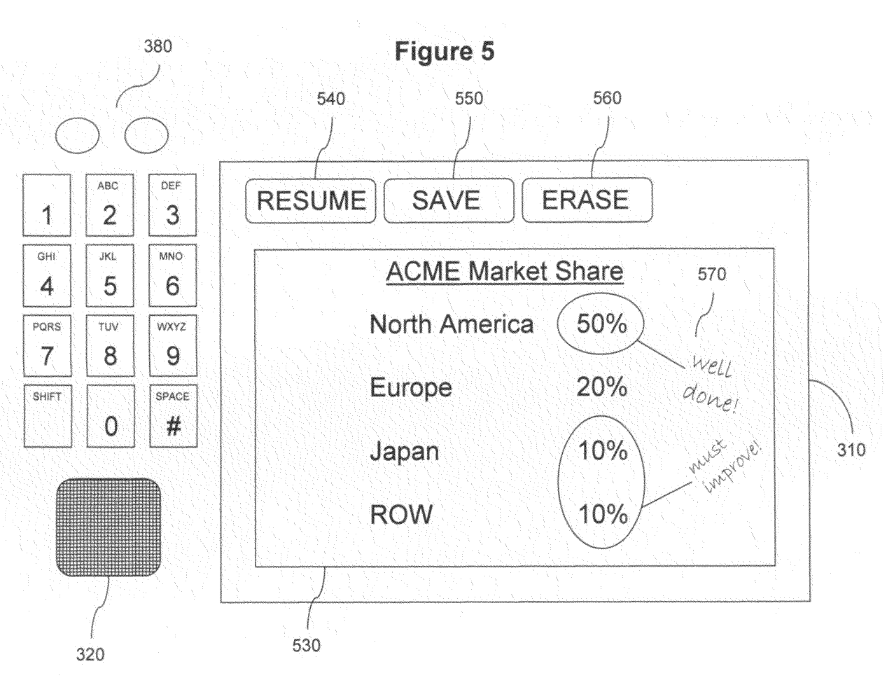

Next, MFP device 110 under control of processor 240 generates an A/V file containing the recorded video and audio sequences (720) and transmits the A/V file to one or more destinations (725). Turning to FIG. 5, in response to depression by the walk-up user of the STOP button 460, a recording disposition page is displayed on touch screen video display 310. The recording disposition page displays action buttons including a RESUME button 540, a SAVE button 550 and an ERASE button 560. The recording disposition page also displays a marked-up version of editable image 530 showing edits 570 made by the walk-up user during the recording session. Edits 570 are shown to include circles, lines and text added to the original version of editable image 430, although other types of modifications are possible. At this point, the walk-up user may return to the recording session page and resume the recording session by depressing RESUME button 540. The walk-up user may erase the recorded sequences and return to the home page by depressing ERASE button 560. The walk-up user may save the recorded sequences as an A/V file and transmits the A/V file by depressing SAVE button 550 and answering follow-on queries. More particularly, when SAVE button 550 is depressed, the walk-up user is queried for a file name, file format and one or more destinations for an A/V file containing the recorded sequences, and MFP device 110 under control of processor 240 generates and transmits an A/V file in conformance with the query responses. Specified destinations for the A/V file may include memory 250, one or more external storage elements, and/or one or more network destinations, such as remote storage devices and/or remote playback devices.

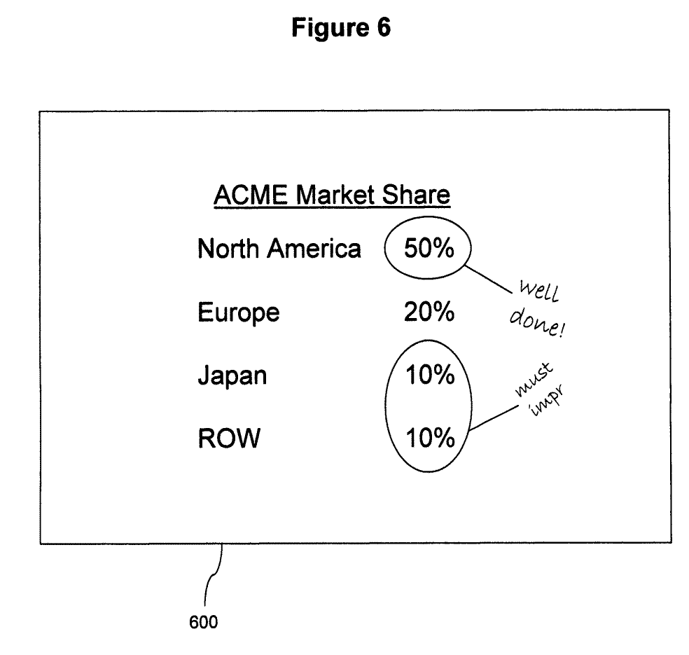

FIG. 6 shows a bitmap image 600 capturing edits made to editable image 430 in some embodiments of the invention. Bitmap image 600 is a snapshot of the digital image taken as conversion to edited image 530 is in process. A video sequence is created from a time-stamped series of bitmap images such as image 600, resulting in a video presentation with the appearance of full motion video. An audio sequence capturing sounds detected by microphone 320 is added to the video sequence to provide audio commentary as an accompaniment.

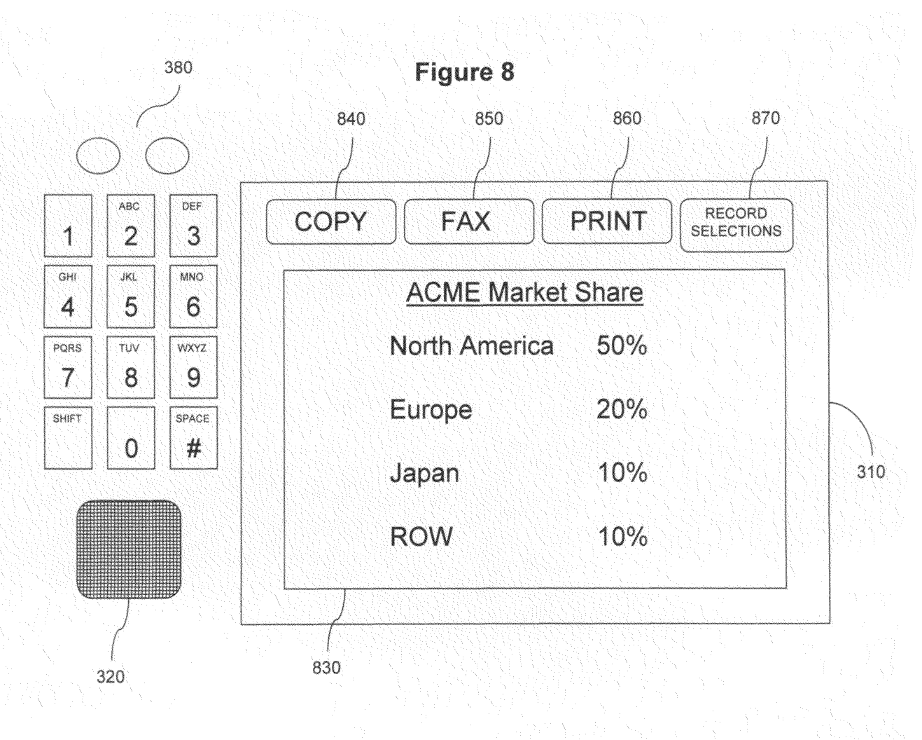

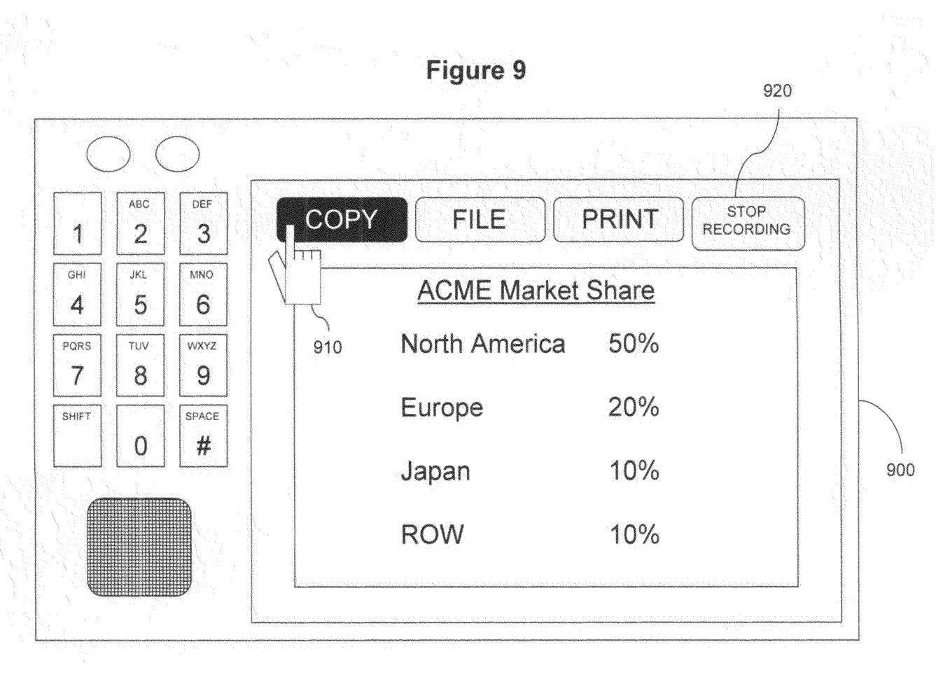

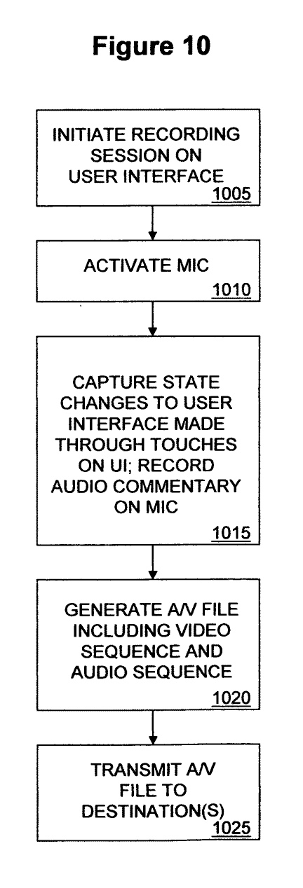

FIG. 10 shows a cameraless method for documenting in an A/V sequence state changes to user interface 210 in some embodiments of the invention. This method will be described in conjunction with FIGS. 8 and 9.

At the outset, a walk-up user approaches MFP device 110 and initiates a recording session that will document in an A/V sequence state changes to user interface 210 resulting from interaction with a walk-up user (1005). Turning to FIG. 8, when the walk-up user arrives at MFP device 110, user interface 210 displays a home page on touch screen video display 310. The home page displays action buttons including a COPY button 840, a FAX button 850, a PRINT button 860 and a RECORD SELECTIONS button 870. The home page also displays a current digital image 830. The walk-up user initiates the recording session by depressing RECORD SELECTIONS button 870 by hand or using a stylus, for example.

Next, in response to initiation of the recording session, MFP device 110 under control of processor 240 activates microphone 320 (1010).

Next, MFP device 110 under control of processor 240 captures state changes to user interface 210 made through walk-up user interaction with user interface 210, and accompanying audio commentary spoken into microphone 320 by the walk-up user (1015). State changes may result, for example, from hand or stylus touches on touch screen video display 310 or hard keys 380. The state changes are captured in a series of time-stamped bitmap images of user interface 210 each reflecting the present, evolving state of user interface 210. The bitmap images and accompanying audio data capturing sounds detected by microphone 320 are stored in memory 250. State changes are highlighted in the video sequence by altering the appearance of selected objects in bitmap images, for example, using color inversion or adding animated icons (e.g. arrow, hand, finger, etc.) that hover over selected objects. For example, FIG. 9 shows an exemplary bitmap image 900 that documents a selection of COPY button 840 during a recording session. The selection is highlighted by inverting the color of COPY button 840 and also showing an animated hand 910 hovering over the button. The walk-up user terminates the recording session by depressing the STOP RECORDING SELECTIONS button 920, at which point the user is queried how he or she wishes to dispose of the recorded sequences. Generally, imaging device 110 under control of the processor 240, and in accordance with walk-up user instructions, saves the recorded sequences as an A/V file (1020) and transmits the A/V file to one or more destinations (1025). Specified destinations for the A/V file may include memory 250, one or more external storage elements, and one or more network destinations, such as remote storage devices and/or remote playback devices.

Naturally, the particular pages and hard keys shown in the figures are merely illustrative. Pages and hard keys may be presented in a variety of layouts and may support a variety of features and functions within the inventive scope.

Accordingly, it will be appreciated by those of ordinary skill in the art that the invention can be embodied in other specific forms without departing from the spirit or essential character hereof. For example, in some embodiments, instead of simultaneously recording the video and audio sequences in a single recording session, the video sequence is recorded first. Then, at a time convenient for the walk-up user, the video sequence is played-back on user interface 210 and the audio sequence is recorded while the video sequence is being played-back.

The present description is therefore considered in all respects to be illustrative and not restrictive. The scope of the invention is indicated by the appended claims, and all changes that come with in the meaning and range of equivalents thereof are intended to be embraced therein.

What is claimed is:

1. A multifunction peripheral (MFP) device, comprising:
a user interface having a touch screen video display and a microphone;
a network interface; and
a processor communicatively coupled with the user interface and the network interface, wherein under control of the processor the MFP device generates an audiovisual (A/V) file containing a video sequence capturing one or more edits made in a cameraless recording session to a digital image rendered on the touch screen video display and an audio sequence capturing one or more sounds detected by the microphone, and transmits the A/V file to a network destination via the network interface.

2. The device of claim 1, wherein the video sequence is created from a series of recorded bitmap images of the digital image each capturing a present state of the digital image.

3. The device of claim 1, wherein the edits are made through touches on the digital image.

4. The device of claim 3, wherein the touches are hand touches.

5. The device of claim 3, wherein the touches are stylus touches.

6. The device of claim 1, wherein the recording session is started and ended in response to touches on the user interface.

7. The device of claim 1, wherein the recording session is paused and resumed in response to touches on the user interface.

8. The device of claim 1, wherein a file format for the NV file is selected in response to a touch on the user interface.

9. The device of claim 1, wherein the destination is selected in response to a touch on the user interface.

10. The device of claim 1, wherein the sounds are detected in the cameraless recording session.

11. The device of claim 1, wherein the sounds are detected in a second cameraless recording session in which the video sequence is played-back on the user interface.

12. An MFP device, comprising:
a user interface having a microphone; and
a processor communicatively coupled with the user interface, wherein under control of the processor the MFP device generates an A/V file containing a video sequence capturing one or more state changes to the user interface in a cameraless recording session and an audio sequence capturing one or more sounds detected by the microphone, and transmits the A/V file to a destination.

13. The device of claim 12, wherein the video sequence is created from a series of recorded bitmap images of the user interface each capturing a present state of the user interface.

14. The device of claim 12, wherein the state changes include state changes made through touches on the user interface.

15. The device of claim 12, wherein the state changes include state changes made through touches on touch panel video display buttons and hard keys.

16. The device of claim 12, wherein a file format and a destination for the A/V file are selected through touches on the user interface.

17. The device of claim 12, wherein the sounds are detected during the cameraless recording session.

18. The device of claim 12, wherein the sounds are detected after the cameraless recording session during playback of the video sequence.

19. The device of claim 12, wherein the destination is on the MFP device.

20. The device of claim 12, wherein the destination is a destination device that is communicatively coupled with the MFP device over a communication network.
